(19) United States
(12) Patent Application Publication
(10) Pub. No.: US 2025/0364201 A1
(43) Pub. Date: Nov. 27, 2025

(54) SLOW-WAVE STRUCTURE, TRAVELING WAVE TUBE, ELECTRONIC DEVICE, AND COMMUNICATION SYSTEM

(71) Applicant: HUAWEI TECHNOLOGIES CO., LTD., Shenzhen (CN)

(72) Inventors: Xin Wang, Chengdu (CN); Qianfu Cheng, Chengdu (CN); Jie Xie, Chengdu (CN); Hua Cai, Chengdu (CN); Guangjian Wang, Shenzhen (CN)

(21) Appl. No.: 19/294,470

(22) Filed: Aug. 8, 2025

Related U.S. Application Data
(63) Continuation of application No. PCT/CN2023/075105, filed on Feb. 9, 2023.

(51) Int. Cl. H01J 23/24; H01J 25/36

(52) U.S. Cl. CPC H01J 23/24; H01J 25/36

(57) ABSTRACT

A slow-wave structure, a traveling wave tube, an electronic device, and a communication system are provided. The slow-wave structure includes a folded waveguide structure, where the waveguide structure has a cycle in a longitudinal direction and an amplitude in a transverse direction perpendicular to the longitudinal direction, and at least one of an amplitude of a first part of the waveguide structure and a cycle of the first part gradually changes in the longitudinal direction. Therefore, reflection of the slow-wave structure can be reduced, backward wave oscillation can be effectively suppressed, and a wider operating bandwidth can be obtained.

### CROSS-REFERENCE TO RELATED APPLICATIONS

This application is a continuation of international application No. PCT/CN2023/075105, filed on Feb. 9, 2023, the disclosure of which is hereby incorporated by reference in its entirety.

### TECHNICAL FIELD

This application relates to the communication field, and more specifically, to a slow-wave structure, a traveling wave tube, an electronic device, and a communication system.

### BACKGROUND

A traveling wave tube (TWT) is the most important one of vacuum electronic devices, has characteristics such as large power, wide band, small size, and light weight, and is widely used in communication, radar imaging, electronic countermeasures, and the like. As an important part of the traveling wave tube, a slow-wave structure (SWS) can convert direct-current energy of an electron beam into energy of an electromagnetic wave through interaction between the electron beam and the electromagnetic wave transmitted along the slow-wave structure.

Through improvement on electronic efficiency of the traveling wave tube, total efficiency of the traveling wave tube can be improved, and an output power, a gain, and the like can also be improved. A phase velocity of the electromagnetic wave transmitted along the slow-wave structure is synchronized with a velocity of the electron beam, so that the electronic efficiency of the traveling wave tube can be improved. Because the velocity of the electron beam does not linearly change, the conventional slow-wave structure usually satisfies the synchronization relationship through a change of the multi-segment discrete phase velocity jumping slow-wave structure. The structure design increases complexity of the slow-wave structure and leads to instability of overall performance.

### SUMMARY

Embodiments of this application provide a slow-wave structure, a traveling wave tube, an electronic device, and a communication system, to reduce reflection of the slow-wave structure, suppress backward wave oscillation, improve electronic efficiency, and obtain a wider operating bandwidth.

According to a first aspect, a slow-wave structure is provided. The slow-wave structure includes a folded waveguide structure, where the waveguide structure has a cycle in a longitudinal direction and an amplitude in a transverse direction perpendicular to the longitudinal direction, and at least one of an amplitude of a first part of the waveguide structure and a cycle of the first part gradually changes in the longitudinal direction. Therefore, reflection of the slow-wave structure can be reduced, backward wave oscillation can be effectively suppressed, and a wider operating bandwidth can be obtained.

In some implementations of the first aspect, the first part of the waveguide structure may satisfy at least one of the following: the amplitude of the first part continuously increases in the longitudinal direction; or the cycle of the first part continuously decreases in the longitudinal direction. Therefore, a phase velocity of an electromagnetic wave can be continuously reduced in the longitudinal direction.

In some implementations of the first aspect, the amplitude or the cycle of the first part may satisfy any one of the following function relationships: an exponential function, a logarithmic function, a polynomial function, or a trigonometric function. In this manner, a full-cycle gradient phase velocity may be implemented during the whole cycle in the entire slow-wave structure by using a small quantity of variable parameters.

In some implementations of the first aspect, an amplitude in the transverse direction and a cycle in the longitudinal direction of a second part of the waveguide structure may remain unchanged in the longitudinal direction, and the second part is closer to an input end of the slow-wave structure than the first part. Therefore, the phase velocity of the electromagnetic wave can better match a velocity of an electron beam, thereby improving interaction efficiency.

In some implementations of the first aspect, an amplitude of a second part of the waveguide structure in the transverse direction may be less than the amplitude of the first part, the amplitude of the second part may continuously increase in the longitudinal direction at an amplitude change rate less than an amplitude change rate of the first part, and the second part is closer to an input end of the slow-wave structure than the first part. Therefore, the phase velocity of the electromagnetic wave can better match a velocity of an electron beam, thereby improving interaction efficiency.

In some implementations of the first aspect, a cycle of a second part of the waveguide structure in the longitudinal direction may be greater than the cycle of the first part, the cycle of the second part may continuously decrease in the longitudinal direction at a cycle change rate less than a cycle change rate of the first part, and the second part is closer to an input end of the slow-wave structure than the first part. Therefore, the phase velocity of the electromagnetic wave can better match a velocity of an electron beam, thereby improving interaction efficiency.

In some implementations of the first aspect, the slow-wave structure may further include an attenuator disposed between the first part and the second part. Therefore, the backward wave oscillation can be further suppressed.

In some implementations of the first aspect, the waveguide structure may include a folded waveguide. Therefore, an improved waveguide type slow-wave structure can be implemented.

In some implementations of the first aspect, the waveguide structure may include a folding line. Therefore, an improved folding line type slow-wave structure can be implemented.

In some implementations of the first aspect, the slow-wave structure may further include: a metal tube shell, extending in the longitudinal direction; and a dielectric support member, insulated from the metal tube shell and supporting the waveguide structure. Therefore, an improved folding line type slow-wave structure can be implemented.

In some implementations of the first aspect, the folding line may include double layers of folding lines. Therefore, electronic efficiency can be improved.

In some implementations of the first aspect, the slow-wave structure may include a first ridge structure and a second ridge structure that are located on opposite sides of the double layers of folding lines, and the first ridge structure and the second ridge structure are parallel to planes on which the double layers of folding lines are located, respectively. Through the ridge structures, impedance of the folding line may be adjusted, thereby adjusting a dispersion characteristic of the slow-wave structure.

According to a second aspect, a traveling wave tube is provided. For beneficial effects, refer to the descriptions of the first aspect. Details are not described herein again. The traveling wave tube includes: an input/output apparatus, an electronic transceiver component, a focusing component, and the slow-wave structure according to any one of the implementations of the first aspect, where the input/output apparatus is configured to input an electromagnetic wave to an input end of the slow-wave structure, and output the electromagnetic wave from an output end of the slow-wave structure. Therefore, reflection of the slow-wave structure can be reduced, backward wave oscillation can be effectively suppressed, a wider operating bandwidth can be obtained, and operating stability of the traveling wave tube can be improved.

In some implementations of the second aspect, the electronic transceiver component may be configured to emit the electron beam on a planar cathode emitting surface. Therefore, a manufacturing process can be simplified, and manufacturing costs can be reduced.

In some implementations of the second aspect, the electron beam may be a strip-shaped electron beam or a transversely divergent electron beam. Therefore, flexibility of a structure design of the traveling wave tube can be improved.

According to a third aspect, an electronic device is provided. For beneficial effects, refer to the descriptions of the first aspect. Details are not described herein again. The electronic device includes: a power supply apparatus; and the traveling wave tube according to any one of the implementations of the second aspect, powered by the power supply apparatus. Therefore, the electronic device with a wide bandwidth, high electronic efficiency, and high stability can be provided.

According to a fourth aspect, a communication system is provided. For beneficial effects, refer to the descriptions of the first aspect. Details are not described herein again. The communication system includes: the traveling wave tube according to any one of the implementations of the second aspect. Therefore, the communication system can have a wide bandwidth, high electronic efficiency, and high stability.

In some implementations of the fourth aspect, the communication system may further include at least one of the following: a baseband, an intermediate radio frequency module, and an antenna.

### BRIEF DESCRIPTION OF DRAWINGS

The foregoing and other features, advantages, and aspects of embodiments of this application become clearer with reference to accompanying drawings and the following detailed descriptions. In the accompanying drawings, same or similar reference numerals indicate same or similar elements.

FIG. 1A is a block diagram of a communication system to which an embodiment of this disclosure is applicable;

FIG. 1B is a diagram of a structure of a traveling wave tube to which an embodiment of this disclosure is applicable;

FIG. 2A is a diagram of a multi-segment phase velocity jumping slow-wave structure;

FIG. 2B is a diagram of a phase velocity at which an electromagnetic wave is transmitted on the slow-wave structure in FIG. 2A;

FIG. 3A is a diagram of a radial line slow-wave structure;

FIG. 3B is a diagram of another radial line slow-wave structure;

FIG. 4A to FIG. 4D are diagrams of a slow-wave structure including a folding line according to an embodiment of this application;

FIG. 5 is a diagram of a folding line of a slow-wave structure according to an embodiment of this application;

FIG. 6A to FIG. 6E are diagrams of a slow-wave structure including double layers of folding lines according to an embodiment of this application;

FIG. 7A to FIG. 7D are simulation results of the slow-wave structure in FIG. 6A to FIG. 6E;

FIG. 8A and FIG. 8B are diagrams of a slow-wave structure including a plurality of segments of folding lines according to an embodiment of this application;

FIG. 8C is a diagram of a phase velocity of an electromagnetic wave transmitted on the slow-wave structure in FIG. 8A and FIG. 8B;

FIG. 9A is a diagram of a traveling wave tube including a slow-wave structure with a V-shaped folding line according to an embodiment of this application;

FIG. 9B is a diagram of a traveling wave tube including a slow-wave structure with an S-shaped folding line according to an embodiment of this application; and

FIG. 10 is a diagram of a slow-wave structure including a folded waveguide according to an embodiment of this application.

### DESCRIPTION OF EMBODIMENTS

The following describes embodiments of this application in more detail with reference to the accompanying drawings. Although some embodiments of this application are shown in the accompanying drawings, it should be understood that this application may be implemented in various forms, and should not be construed as being limited to embodiments described herein. On the contrary, these embodiments are provided for a more thorough and complete understanding of this application. It should be understood that, the accompanying drawings and embodiments of this application are merely used as examples, and are not intended to limit the protection scope of this application.

In the descriptions of embodiments of this application, the term “include” and similar terms thereof should be understood as open inclusion, that is, “include but not limited to”. The term “based on” should be understood as “at least partially based on”. The term “one embodiment” or “this embodiment” should be understood as “at least one embodiment”. The terms “first”, “second”, and the like may indicate different objects or a same object. Other explicit and implicit definitions may also be included below.

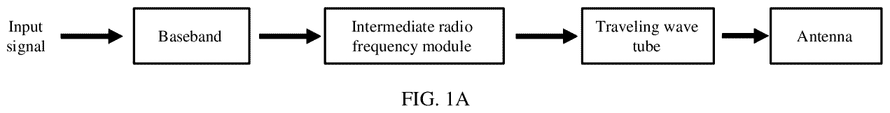

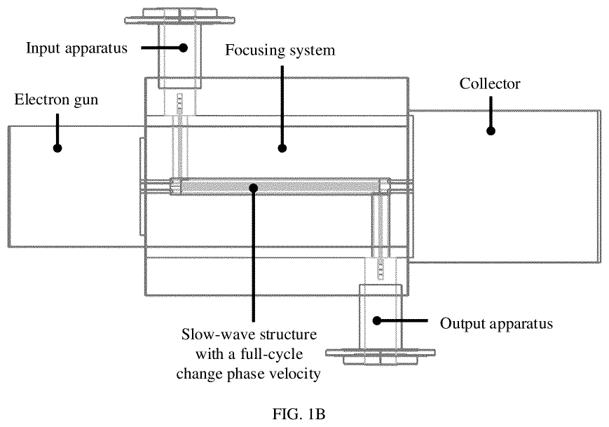

A traveling wave tube is the most important one of vacuum electronic devices, has characteristics of large power, wide band, small size, light weight, and the like, and is widely used in communication, radar imaging, electronic countermeasures, and the like. The technical solutions in the embodiments of this application are mainly applied to wireless communication system application scenarios such as a radio frequency/microwave/millimeter wave/THz base station, an in-vehicle device, and a satellite load. FIG. 1A is a block diagram of a communication system to which an embodiment of this disclosure is applicable. A communication system (for example, a base station system) using a traveling wave tube amplifier includes an input signal, a baseband, an intermediate radio frequency module, a traveling wave tube, and an antenna, and is mainly configured to satisfy applications such as point-to-point (P2P) or point-to-multiple point (P2MP) backhaul. The baseband is configured to implement processing such as encoding and pre-distortion on the input signal. The intermediate radio frequency module is configured to implement functions such as digital-to-analog conversion, signal up-conversion, amplification, and filtering on a baseband phase signal, and output a constant envelope phase modulation radio frequency signal that satisfies saturation operation of the traveling wave tube. The traveling wave tube is configured to amplify the constant envelope phase modulation signal from the intermediate radio frequency module, and transmit an amplified signal to the antenna. The antenna is configured to radiate, into free space, the signal amplified by the traveling wave tube.

FIG. 1B is a diagram of a structure of a traveling wave tube to which an embodiment of this disclosure is applicable. The traveling wave tube mainly includes an electron gun, an input/output apparatus, a slow-wave structure, a focusing system, and a collector. The electron gun is configured to emit electrons, and the emitted electrons pass through a slow-wave circuit under beam bunching of the magnetic focusing system and finally enter the collector. The slow-wave structure is a core component of an energy conversion structure of the traveling wave tube, and is configured to convert kinetic energy of the electrons into energy of an electromagnetic wave through interaction between the electromagnetic wave transmitted in the slow-wave structure and an electron beam, to amplify the electromagnetic wave. An input apparatus is configured to input a to-be-amplified signal to a slow-wave line through conversion from a TE10 mode to a (quasi-) TEM mode, to modulate the electron beam. An output apparatus is configured to couple the amplified signal into an external circuit. The electrons emitted by the electron gun enter the slow-wave circuit under the beam bunching effect of the focusing system, are modulated by a signal fed from the input apparatus, form a bunch in a direction (namely, a transmission direction of the electron beam) of the interaction between the electromagnetic wave and the electron beam, and gradually transfer energy to the electromagnetic wave, that is, convert the kinetic energy of the electron beam into the energy of the electromagnetic wave. The collector is configured to recover remaining energy of the electrons that interact with the electromagnetic wave.

To improve efficiency of the traveling wave tube, improvements are usually made on efficiency of the electrons, efficiency of the collector, and the like. An energy conversion structure (namely, the slow-wave structure of the traveling wave tube) that meets a specific requirement may be designed according to a research objective, so that the traveling wave tube converts direct current energy of the electron beam into the energy of the electromagnetic wave through the slow-wave structure. In addition, the efficiency of the collector can be improved through the design of a multi-stage depressed collector. Through improvement on electronic efficiency of the traveling wave tube, total efficiency of the traveling wave tube can be improved, and an output power, a gain, and the like can also be improved. Therefore, in a vacuum electronics field, various improvements are made for various types of slow-wave structures (including a spiral line type slow-wave structure, a coupled cavity type slow-wave structure, a folded waveguide type slow-wave structure, and a folding line type slow-wave structure), to improve the electronic efficiency as much as possible while satisfying a gain and a bandwidth of the traveling wave tube amplifier, and ensure stability of long-time operation.

In the exploration process, a phase velocity jumping technology is widely applied to design of the slow-wave structures. The theoretical basis of the technology is as follows: The electron beam interacts with the electromagnetic wave transmitted along the slow-wave structure, the electron beam continuously converts the kinetic energy of the electron beam into the energy of the electromagnetic wave, then the velocity of the electron beam gradually decreases, the phase velocity of the electron beam is changed from a slightly greater velocity than the phase velocity of the electromagnetic wave to a smaller velocity than the phase velocity of the electromagnetic wave, and therefore the electromagnetic wave transmitted on the slow-wave structure is no longer amplified, that is, the energy conversion between the electron beam and the electromagnetic wave is dynamically balanced. The phase velocity jumping technology changes a size of the slow-wave structure, so that the phase velocity of the electromagnetic wave transmitted on the slow-wave structure changes with the velocity of the electron beam, and the electromagnetic wave and the electron beam can be resynchronized to improve the electronic efficiency. Because the velocity of the electron beam does not linearly decrease, the phase velocity jumping technology usually satisfies the synchronization relationship through a plurality of structure changes.

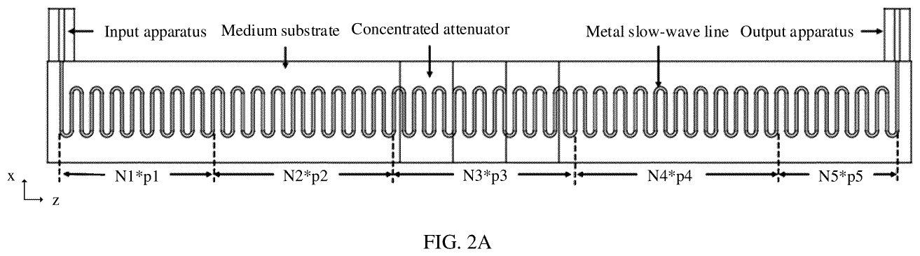

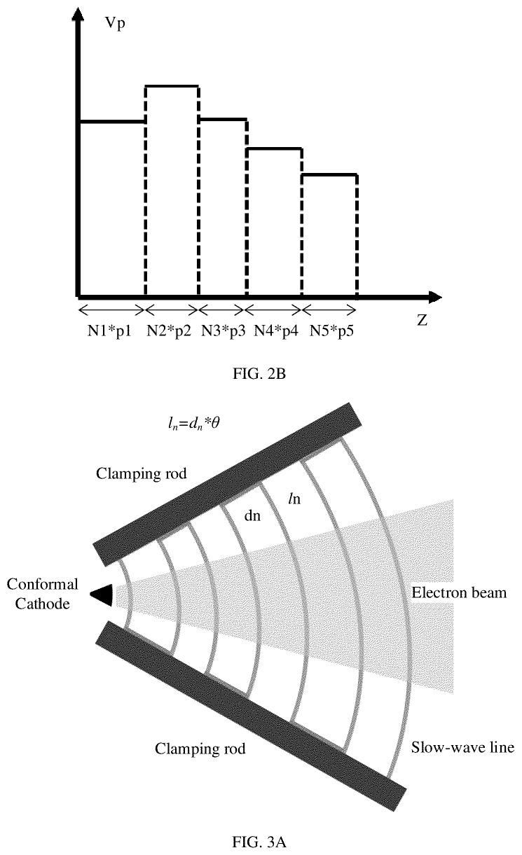

FIG. 2A is a diagram of a related multi-segment phase velocity jumping slow-wave structure. FIG. 2B is a diagram of a phase velocity Vp at which the electromagnetic wave is transmitted on the slow-wave structure in FIG. 2A. As shown in FIG. 2A, a metal folded slow-wave line is etched on the slow-wave structure of a traveling wave tube by using a dielectric substrate. In a process of interaction between the electron beam and the slow-wave structure, the electron beam is affected by electric field force in a longitudinal direction (a z direction), so that some electrons accelerate, and the other electrons decelerate. Therefore, the phase velocity of the electromagnetic wave transmitted along the slow-wave line may have a positive jump or a negative jump of the phase velocity. In the slow-wave structure shown in FIG. 2A, a cycle of the slow-wave line is changed, so that the phase velocity discretely changes. The entire slow-wave line is divided into several segments (in FIG. 2A, five segments are used as an example), and cycle lengths (p1, p2, p3, p4, and p5) and cycle quantities (N1, N2, N3, N4, and N5) of the segments are different. The phase velocity of the electromagnetic wave transmitted along the slow-wave line is directly related to the corresponding cycle length of the slow-wave line. A shorter cycle length of the slow-wave line indicates a smaller phase velocity of the electromagnetic wave transmitted along the slow-wave line. To match the phase velocity of the electromagnetic wave with the velocity of the electron beam, because the velocity of the electron beam gradually decreases, the cycle lengths of the slow-wave line discretely decrease in a transmission direction (the z direction) of the electron beam, that is, p2>p3>p4>p5. In addition, because a velocity of the electron beam slightly changes at an initial stage, a cycle length of a first segment of the slow-wave line may be slightly shorter than a cycle length of a second segment of the slow-wave line, that is, p1<p2. As shown in FIG. 2B, the phase velocity of the electromagnetic wave transmitted along the slow-wave line discretely changes in the transmission direction (the z direction) of the electron beam, so that the phase velocity of the electromagnetic wave matches the velocity of the electron beam. The slow-wave line is divided into several segments in the longitudinal direction (the z direction), the electromagnetic wave has a fixed phase velocity in each segment, the phase velocity discretely increases (or decreases) along the slow-wave line, the electron beam is better synchronized with the electromagnetic wave transmitted along the slow-wave line, and this is referred to as a phase velocity resynchronization technology. The phase velocity changes through a plurality of structure jumps (usually of a cycle, a screw pitch, a radius, or the like), so that the electromagnetic wave is resynchronized with the electron beam, and the electromagnetic wave more effectively exchanges energy with the electron beam, thereby improving electronic efficiency.

To allow the phase velocity of the electromagnetic wave to change multiple times, the multi-segment discrete phase velocity jumping slow-wave structure is applied in some solutions, that is, the slow-wave structure includes a plurality of segments with discrete jumping phase velocities. This complicates the slow-wave structure, and increases the difficulty of machining and assembling. In addition, a plurality of reflection points are inevitably introduced in the slow-wave structure circuit, increasing the risk of reflection oscillation in the traveling wave tube to some extent and affecting overall performance. For example, when the electromagnetic wave is transmitted on the slow-wave line, the electromagnetic wave is reflected at discontinuous points. A propagation direction (a −z direction) of a reflected wave is opposite to a forward direction (the z direction) of the electron beam. The electromagnetic wave transmitted in a reverse direction and the electron beam do not meet a synchronization condition, and therefore do not interact. However, when the reflected wave is transmitted in a direction toward an input end, secondary reflection occurs at the discontinuous points. A secondary reflection signal is transmitted along the slow-wave line toward an output end. If a secondary reflection wave is greater than a weak electromagnetic wave input at the input end, the oscillation may occur at an appropriate frequency in the repeated process. Even if no oscillation is generated, the secondary reflection wave or even a triple reflection wave is vectorially superposed with the input electromagnetic wave, causing gain and phase fluctuation and causing the unstable operation of the traveling wave tube. When a plurality of reflection points exist on the slow-wave line, instability of the traveling wave tube is further increased.

In the slow-wave circuit, backward wave oscillation may be suppressed through cutting and an attenuator. However, this may further complicate the slow-wave structure, reduce a gain of the traveling wave tube, and increase a length of the traveling wave tube.

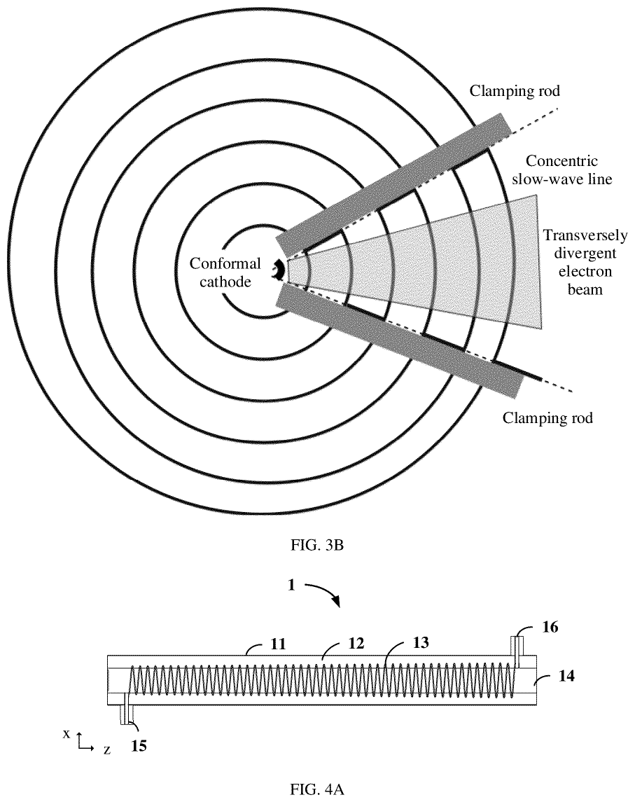

In addition to the non-uniform slow-wave line implemented through multi-segment jumping, some related technologies further use a radial slow-wave line solution. FIG. 3A is a diagram of a related radial line slow-wave structure. As shown in FIG. 3A, a slow-wave line is in a logarithmic cycle change relationship, where a functional relational expression is l=a₀e^{b}^{₀}^{θ}−r₀, an angle in an angular direction is θ, a radius of an n^{th} segment is dn, and a normalized phase velocity is vpc=1/(π/2+θ/(e^{πb}−e^{-πb})). It can be learned that the phase velocity of the slow-wave line is a fixed value when the angle θ and an exponential change coefficient b are fixed. In other words, although the slow-wave line changes in a radial direction, the phase velocity of the electromagnetic wave in the slow-wave line is constant. The slow-wave line that spreads in the angular direction better interacts with the transversely divergent electron beam, but electron efficiency cannot be improved through resynchronization of the phase velocity. FIG. 3B is a diagram of another related radial line slow-wave structure. As shown in FIG. 3B, a slow-wave line is formed by concentric arcs. The phase velocity of the electromagnetic wave in the slow-wave line is constant, and is determined by the angle and the adjacent concentric arcs.

The phase velocity of the electromagnetic wave transmitted along the radial slow-wave line is constant, and this is not conducive to energy exchange between the electromagnetic wave and the electron beam, and therefore is not conducive to improving the electronic efficiency. Although the electronic efficiency may be subsequently improved in other manners (for example, adding a ridge, changing a structure parameter (a cycle) of a radial line, and the like), these manners may result in disadvantages of the slow-wave structure shown in FIG. 2A. That is, the complexity of the slow-wave structure is increased, and the phase velocity does not continuously change in the entire cycle. This reduces an operating bandwidth and increases the oscillation risk of a traveling wave tube.

In addition, in the radial slow-wave structure, if a conventional planar cathode is configured to emit an electron beam, phases of the electron beam on one cross section at a specific longitudinal position are inconsistent, resulting in extremely low electron efficiency. To allow the electromagnetic wave to interact with the electron beam, the radial line slow-wave structure requires a cathode emitting surface of an electron gun to be conformal with the slow-wave line in the angular direction. That is, the cathode emitting surface of the electron beam has a same radian as the arcs of the slow-wave line, to ensure that the electron beam emitted by the cathode emitting surface can simultaneously interact with an interaction field in the radial direction, thereby implementing energy exchange between the electron beam and the electromagnetic wave. However, the cathode emitting surface is constrained to be conformal with the slow-wave line, and therefore design, processing and assembling of an electrode of the electron gun are more complex.

At present, there is no effective solution to achieve the objectives such as wide bandwidth, high electronic efficiency, and high stability of the traveling wave tube without increasing the complexity of the traveling wave tube system. The conventional traveling wave tube uses the discrete phase velocity jumping slow-wave structure to improve the electronic efficiency. This increases the structure complexity, reduces the operating bandwidth, and increases the oscillation risk of the traveling wave tube. In addition, the traveling wave tube with the radial slow-wave line cannot take into account the overall performance, including bandwidth, electronic efficiency, gain, stability, structure, and process complexity.

To achieve the objectives such as wide bandwidth, high efficiency, and high stability of the traveling wave tube without increasing complexity of the traveling wave tube system, embodiments of this application provide a slow-wave structure with a full-cycle gradient phase velocity and a traveling wave tube based on the slow-wave structure. In this solution, the slow-wave structure has a folded waveguide structure, where the waveguide structure has a cycle in a longitudinal direction and an amplitude in a transverse direction perpendicular to the longitudinal direction, and at least one of an amplitude of a first part of the waveguide structure and a cycle of the first part gradually changes in the longitudinal direction. In the foregoing manner, the slow-wave structure can implement continuous changes of the phase velocity of the electromagnetic wave, so that the electromagnetic wave can fully interact with the electron beam while wide-band matching is implemented. On this basis, a planar traveling wave tube with high electronic efficiency and high stability can be constructed.

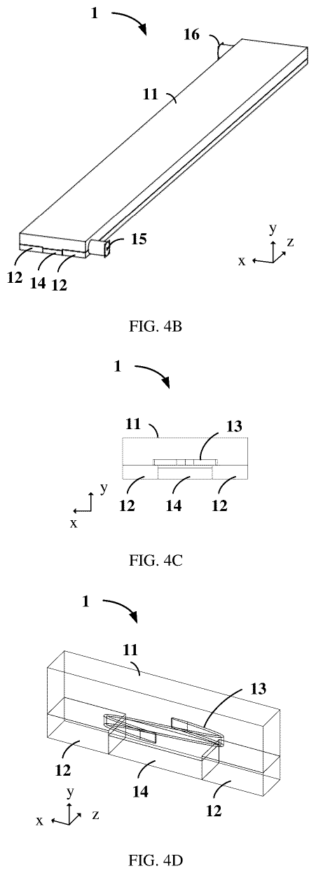

The foregoing embodiments disclosed in this application may be applicable to any other implementation. This is not limited thereto. To discuss embodiments disclosed in this application more clearly, embodiments disclosed in this application are described with reference to FIG. 4A to FIG. 10.

FIG. 4A to FIG. 4D show, in different views, a schematic structure of a slow-wave structure 1 including a folding line according to an embodiment of this application. Specifically, FIG. 4A shows, by using a side view on an xz plane, a schematic structure of the slow-wave structure 1 including the folding line according to an embodiment of this application. FIG. 4B shows, by using a three-dimensional diagram, a schematic structure of the slow-wave structure 1 including the folding line according to an embodiment of this application. FIG. 4C shows, by using a cross section on an xy plane, a schematic structure of the slow-wave structure 1 including the folding line according to an embodiment of this application. FIG. 4D shows, by using a perspective diagram, a schematic structure of a part of the slow-wave structure 1 including the folding line according to an embodiment of this application. The slow-wave structure 1 includes a folded slow-wave line 13. In this disclosure, the folded slow-wave line may include a folded coaxial metal line. When an electromagnetic wave is transmitted on the metal line, a phase velocity is reduced because a path is folded. Therefore, the folded metal line is also referred to as the “folded slow-wave line”. The folded slow-wave line 13 has an amplitude in a transverse direction (namely, an x direction) and a cycle in a longitudinal direction (namely, a z direction). The amplitude, the cycle, or both of the folded slow-wave line 13 may continuously change in the longitudinal direction. In this disclosure, the longitudinal direction represents a transmission direction of an electron beam, and the transverse direction represents a direction perpendicular to the longitudinal direction. Different from the angular direction and the radial direction in FIG. 3A and FIG. 3B, the transverse direction and the longitudinal direction are defined based on the Cartesian coordinate system. In some embodiments, the slow-wave structure 1 may include a metal waveguide tube shell 11 extending in the longitudinal direction, a dielectric support member 12 insulated from the metal waveguide tube shell 11, an input apparatus 15, and an output apparatus 16. The dielectric support member 12 is configured to support the folded slow-wave line 13. In some embodiments, the slow-wave structure 1 may further include a ridge 14 on one side of the folded slow-wave line 13, and both the ridge 14 and the folded slow-wave line 13 extend in the z direction on the xz plane. A height of the ridge 14 is adjusted, so that impedance of the folded slow-wave line 13 can be adjusted, and a dispersion characteristic of the slow-wave structure 1 is adjusted. An electron beam channel may be provided on a side, opposite to the ridge 14, of the folded slow-wave line 13. The folded slow-wave line 13 may be made of a metal material that is resistant to high temperature and is not prone to deformation, for example, molybdenum, a molybdenum alloy, tungsten, or oxygen-free copper. The metal waveguide tube shell 11 may be made of a metal material suitable for a vacuum environment, for example, a nickel-copper alloy, a molybdenum-copper alloy, or oxygen-free copper. The dielectric support member 12 may be made of a ceramic material, for example, boron nitride (BN), beryllium oxide (BeO), silicon carbide (SiC), or aluminum nitride (AlN). The foregoing examples of the metal, the alloy, and the ceramic are merely examples, and the folded slow-wave line 13 and the dielectric support member 12 are not limited to the foregoing materials.

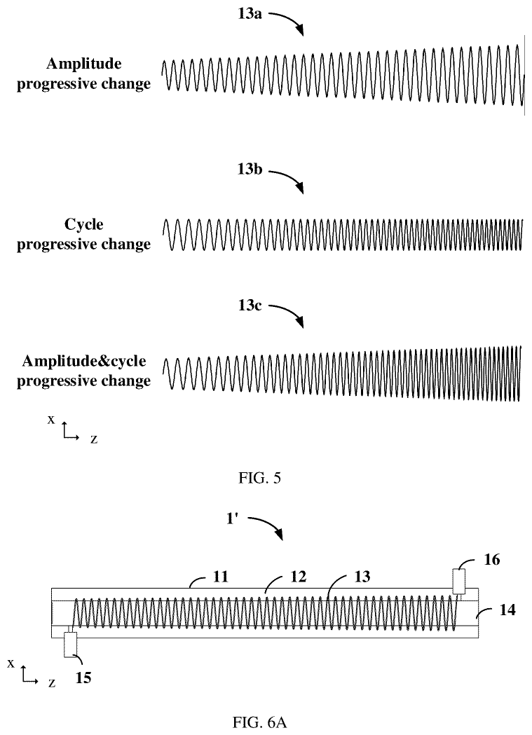

FIG. 5 shows some schematic implementations of the folded slow-wave line 13, for example, folded slow-wave lines 13a, 13b, and 13c. An amplitude of the folded slow-wave line 13a in the transverse direction gradually increases in the longitudinal direction. A cycle of the folded slow-wave line 13b in the longitudinal direction gradually decreases in the longitudinal direction. An amplitude of the folded slow-wave line 13c in the transverse direction gradually increases in the longitudinal direction, and a cycle in the longitudinal direction gradually decreases in the longitudinal direction.

In some embodiments, the folded slow-wave line 13 may satisfy a sine or cosine function relationship:

$${l}_{s w s} ( z ) = A ( z ) * cos ( \frac{2 π}{p ( z )} z ) , or \\ {l}_{s w s} ( z ) = A ( z ) * sin ( \frac{2 π}{p ( z )} z ) .$$

A(z) represents a change relationship of a transverse amplitude of the folded slow-wave line 13 in the longitudinal direction (namely, the z direction), and p(z) represents a change relationship of a longitudinal cycle of the folded slow-wave line 13 in the longitudinal direction. Parameters of the amplitude change function A(z) and the cycle change function p(z) are optimized, so that the phase velocity that is in the longitudinal direction and that is of the electromagnetic wave transmitted in the folded slow-wave line 13 can continuously change, and can keep consistent with a velocity of the electron beam that penetrates through the slow-wave structure and exchanges energy. In other words, the parameters of the amplitude change function A(z) and the cycle change function p(z) may be optimized, so that the phase velocity of the electromagnetic wave transmitted along the slow-wave line can be always synchronized with the electron beam moving in the z direction, thereby achieving relatively high energy conversion efficiency.

In some embodiments, A(z) represents a function that progressively increases in the longitudinal direction. For example, A(z) may satisfy an exponential function, for example, A(z)=A₀*e^{αz}, or A(z)=A₀*2^{αz}, where 0≤z≤L, L represents a length of the folded slow-wave line 13 in the longitudinal direction, Ao represents an initial amplitude of the folded slow-wave line 13, namely, a transverse amplitude at an input end 3, α is an amplitude increase factor, and α>0, so that the transverse amplitude of the folded slow-wave line 13 progressively increases in the longitudinal direction. The transverse amplitude of the folded slow-wave line 13 may also satisfy another function relationship. As another example, A(z) may satisfy a logarithmic function, for example, A(z)=A₀*logₐ(a+αz), where a>1. As yet another example, A(z) may satisfy a polynomial function, for example, A(z)=A₀*(1+αz). As still yet another example, A(z) may satisfy a trigonometric function, for example,

$$A ( z ) = \frac{{A}_{0}}{sin \frac{π}{2 ( α L + 1 )}} * sin \frac{π ( α z + 1 )}{2 ( α L + 1 )} .$$

In some embodiments, p(z) represents a function that progressively decreases in the longitudinal direction. For example, p(z) may satisfy an exponential function, for example, p(z)=p₀*e^{-βz}, or p(z)=p₀*2^{-βz}, where 0≤z≤L, L represents a length of the folded slow-wave line 13 in the longitudinal direction, p₀ represents an initial cycle of the folded slow-wave line 13, that is, a longitudinal cycle at the input end 3, β represents a cycle progressive decrease factor, and −β<0, so that the longitudinal cycle of the folded slow-wave line 13 progressively decreases in the longitudinal direction. The longitudinal cycle of the folded slow-wave line 13 may also satisfy another function relationship. As another example, p(z) may satisfy a logarithmic function, for example, p(z)=p₀*logₐ(a−βz), where a>1+βL. As yet another example, p(z) may satisfy a polynomial function, for example, p(z)=p₀*(1−βz), where β<1/L. As still yet another example, p(z) may satisfy a trigonometric function, for example,

$$p ( z ) = {p}_{0} * cos \frac{π z}{2 β L} ,$$

where β>1.

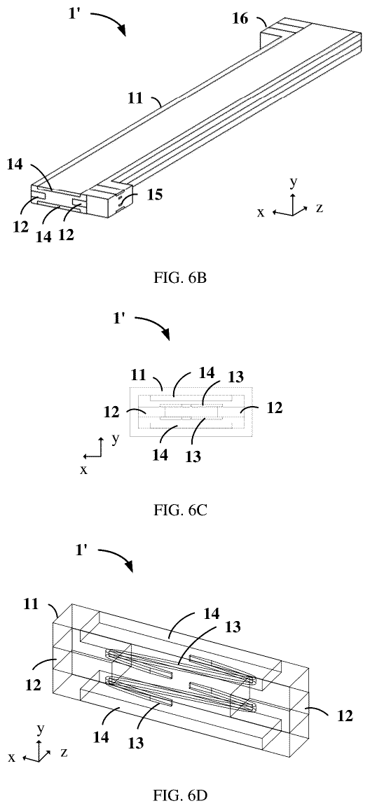

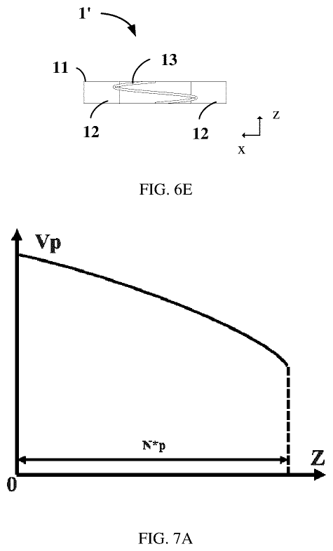

FIG. 6A to FIG. 6E show, by using different views, diagrams of a slow-wave structure 1′ including double layers of folding lines according to an embodiment of this application. Specifically, FIG. 6A shows, by using a side view on an xz plane, a schematic structure of the slow-wave structure 1′ including the double layers of folding lines according to an embodiment of this application. FIG. 6B shows, by using a three-dimensional diagram, a schematic structure of the slow-wave structure 1′ including the double layers of folding lines according to an embodiment of this application. FIG. 6C shows, by using a cross section on an xy plane, a schematic structure of the slow-wave structure 1′ including the double layers of folding lines according to an embodiment of this application. FIG. 6D shows, by using a perspective view, a schematic structure of a part of the slow-wave structure 1′ including the double layers of folding lines according to an embodiment of this application. FIG. 6E shows, by using a cross section on the xz plane, a schematic structure of a part of the slow-wave structure 1′ including the double layers of folding lines according to an embodiment of this application. The slow-wave structure 1′ in FIG. 6A to FIG. 6E is similar to the slow-wave structure 1 in FIG. 4A to FIG. 4D, and a difference lies in that a folded slow-wave line 13′ in the slow-wave structure 1′ includes the double layers of folding lines. Two sides of the folded slow-wave line 13′ are supported by the dielectric support member 12, and the dielectric support member 12 is insulated from the peripheral metal waveguide tube shell 11. It may be understood that this is merely an example, and the slow-wave structure 1′ may further include more layers of folding lines. An even mode (mode 2) of the double-layer folding line structure has a strong axial electric field component, which facilitates interaction with the electron beam. A fundamental mode shows that axial electric fields of upper and lower layers are opposite, and a total electric field is 0, so that interaction with the electron beam cannot be achieved. To better implement mode conversion from a waveguide to a double-layer folding line slow-wave structure, a double-layer microstrip coupling mode with upper and lower ridges is designed. In some embodiments, the slow-wave structure 1′ may further include two ridges 14 on two sides of the double layers of folding lines, and both the ridges 14 and the double layers of folding lines extend in the z direction on the xz plane. A height of the two ridges 14 is adjusted, so that impedance of the double layers of folding lines can be adjusted, and a dispersion characteristic of the slow-wave structure 1′ is adjusted. An electron beam channel may be provided between the double layers of folding lines.

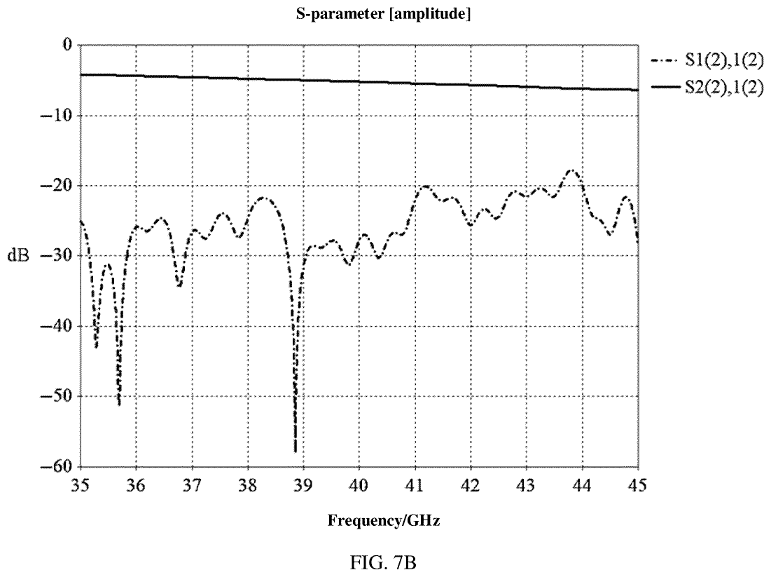

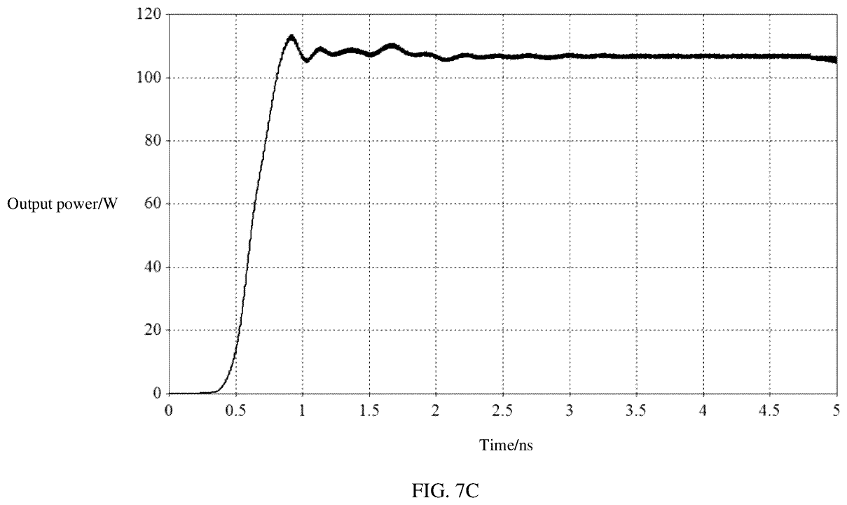

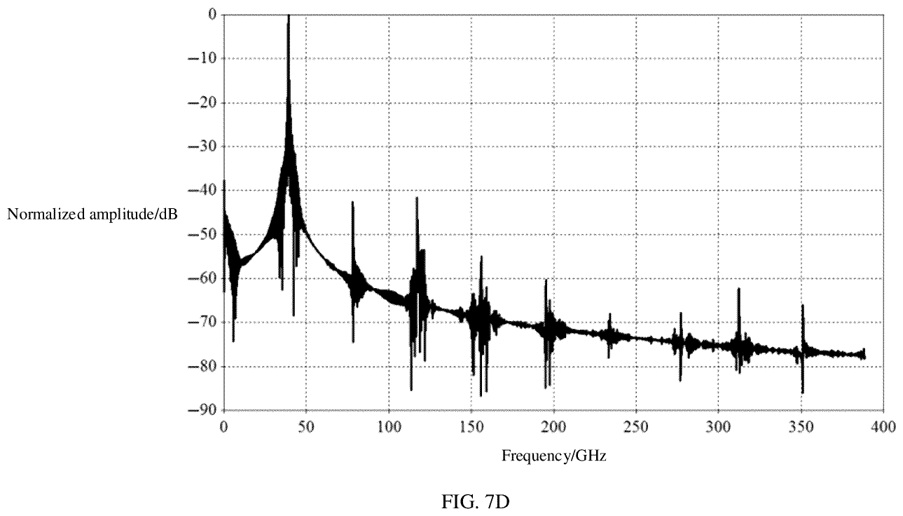

FIG. 7A to FIG. 7D are simulation results of the slow-wave structure 1′ in FIG. 6A to FIG. 6E. For the double-layer slow-wave structure of the slow-wave structure 1′ in FIG. 6A to FIG. 6E, a function change relationship of the slow-wave line is a sine line

$${l}_{s w s} ( z ) = A ( z ) * sin ( \frac{2 π}{p ( z )} z ) ,$$

an amplitude change function is A(z)=A₀*e^{αz}, a cycle change function is p(z)=p₀*(1−βz), α=0.005, and β=0. That is, a transverse amplitude of the folded slow-wave line 13′ gradually increases in the longitudinal direction, and a longitudinal cycle of the folded slow-wave line 13′ remains unchanged. It is assumed that a quantity n of cycles of the folded slow-wave line 13′ is 70, a longitudinal cycle p=0.3 mm, and an interaction length (namely, a length of the slow-wave line in the z direction) is L=n*p=21 mm. Simulation is conducted under the condition that an electron beam voltage is 5.5 kV, a beam current is 0.1 A, and a focusing magnetic field is 0.28 T.

FIG. 7A is a diagram of a change of a phase velocity Vp of an electromagnetic wave transmitted in the slow-wave structure 1′ in the z direction. Parameters of the amplitude change function A(z) and the cycle change function p(z) of the folding lines in the slow-wave structure 1′ are optimized, so that the phase velocity can continuously, monotonously and progressively decrease on the whole.

FIG. 7B is a diagram of a transmission characteristic of the slow-wave structure 1′. As shown in FIG. 7B, the slow-wave structure with a continuous gradient phase velocity can implement good matching between a port and a slow-wave line and in continuous changes of the slow-wave line in a wide frequency range. A return loss is less than −20 dB, and an insertion loss is about −5 dB@40 GHz, which lays a foundation for developing a wide-band traveling wave tube.

FIG. 7C is a diagram of a simulated output power of the slow-wave structure 1′. As shown in FIG. 7C, a 3 dB bandwidth of the slow-wave structure 1′ is within a frequency range of 36.5 GHz to 43 GHz, a maximum output power is 107 W@39 GHz, and electronic efficiency reaches 19.5%. FIG. 7D is a diagram of a spectrum of an output signal of the slow-wave structure 1′. As shown in FIG. 7D, an amplitude difference between a fundamental wave and a higher-order mode in the spectrum of the output signal exceeds 40 dB. That is, in a range of 70 cycles, no backward wave oscillation or reflection oscillation occurs through a continuous gradient phase velocity. The simulation results prove that the planar traveling wave tube can achieve high electron efficiency, wide band and high stability through the continuous gradient slow-wave structure.

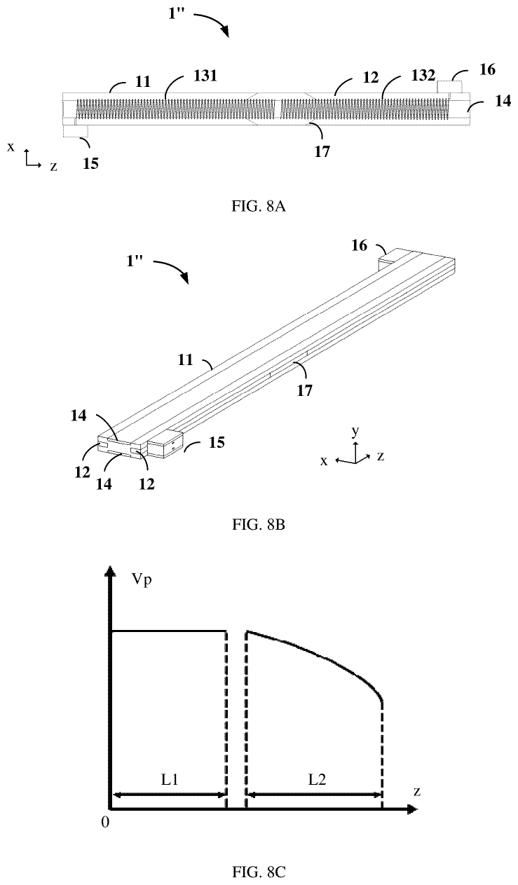

FIG. 8A and FIG. 8B are diagrams of a slow-wave structure 1″ including a plurality of folding lines according to an embodiment of this application. Specifically, FIG. 8A shows, by using a side view on an xz plane, a schematic structure of the slow-wave structure 1″ including the plurality of folding lines according to an embodiment of this application. FIG. 8B shows, by using a three-dimensional diagram, a schematic structure of the slow-wave structure 1″ including the plurality of folding lines according to an embodiment of this application. The slow-wave structure 1″ in FIG. 8A and FIG. 8B is similar to the slow-wave structure 1 in FIG. 4A to FIG. 4D, and a difference lies in that a folded slow-wave line 13″ in the slow-wave structure 1″ includes the plurality of folding lines. In the examples in FIG. 8A and FIG. 8B, the slow-wave structure 1″ includes two folding lines 131 and 132. However, it may be understood that this is merely an example, and the slow-wave structure 1″ may further include more folding lines. Similar to the slow-wave structure 1′ in FIG. 6A to FIG. 6E, each segment of folding line of the slow-wave structure 1″ may include one or more layers of folding lines. In the examples of FIG. 8A and FIG. 8B, the folding lines 131 and 132 each include double layers of folding lines. Two sides of the folding lines 131 and 132 are supported by the dielectric support member 12, and the dielectric support member 12 is insulated from the peripheral metal waveguide tube shell 11. An electron beam channel may be provided between the double layers of folding lines.

As shown in FIG. 8A, one end of the folding line 132 is connected to the input apparatus 15, and the other end is cut and suspended; and one end of the folding line 131 is connected to the output apparatus 16, and the other end is cut and suspended. An attenuator 17 is disposed on the dielectric support member 12 at a suspended position of the folding lines 131 and 132. The attenuator 17 may be vaporized carbon on the folding lines 131 and 132 or on the dielectric support member 12, or may be directly replaced with loss ceramics, is mainly configured to attenuate an electromagnetic wave fed from the input apparatus 15, to avoid forming reflection at a cut position, and is configured to attenuate an electromagnetic wave reflected at a port of the output apparatus 16.

In some embodiments, an amplitude change function A(z) and a cycle change function p(z) of the two folding lines 131 and 132 may have different change relationships. An amplitude increase factor and a cycle progressive decrease factor of the folding line 131 are α1 and β1, respectively. A length of the folding line 131 in the longitudinal direction is L1. An amplitude increase factor and a cycle progressive decrease factor of the folding line 132 are α2 and β2, respectively. A length of the folding line 132 in the longitudinal direction is L2. The folding line 131 is closer to the input apparatus 15 than the folding line 132. In an embodiment, α1=0, β1=0, and at least one of α2 and β2 is not equal to 0. In other words, a transverse amplitude and a longitudinal cycle of the folding line 131 close to the input apparatus 15 remain unchanged, and the folding line 132 close to the output apparatus 16 is implemented in an implementation shown in FIG. 5. In another embodiment, 0<α1<α2. In other words, a change rate of a transverse amplitude of the folding line 131 is less than a change rate of a transverse amplitude of the folding line 132. In another embodiment, 0<β1<β2. In other words, a change rate of a longitudinal cycle of the folding line 131 is less than a change rate of a longitudinal cycle of the folding line 132. Optionally, the transverse amplitude of the folding line 131 at a cut position is equal to or slightly less than the transverse amplitude of the folding line 132 at a cut position. Optionally, the longitudinal cycle of the folding line 131 at a cut position is equal to or slightly greater than the longitudinal cycle of the folding line 132 at a cut position.

FIG. 8C is a diagram of a phase velocity of an electromagnetic wave transmitted on the slow-wave structure 1″ shown in FIG. 8A and FIG. 8B. As shown in FIG. 8C, the phase velocity of the electromagnetic wave transmitted in the folding line 132 decreases continuously, and the phase velocity of the electromagnetic wave transmitted in the folding line 131 is constant, or decreases slowly at a change rate less than a change rate of the folding line 132. Because the velocity of the electron beam changes slightly in an initial phase, the electron beam can be better synchronized with the electromagnetic wave transmitted along the folding line. In addition, different from the jumps shown in FIG. 2B, the phase velocity of the electromagnetic wave changes continuously at the cut position of the folding line 131 and the cut position of the folding line 132. In this way, the reflection generated by the electromagnetic wave at the cut positions can be reduced.

Although the folded slow-wave line in the embodiments shown in FIG. 4A to FIG. 8C is shown to meet a sine or cosine function relationship, this embodiment of this application is not limited thereto. The folded slow-wave line may be any folded shape, including but not limited to a V shape, an S shape, a U shape, or the like, provided that a transverse amplitude of the folded slow-wave line gradually increases, or a longitudinal cycle gradually decreases, or both are satisfied, so that the electromagnetic wave transmitted in the folded slow-wave line gradually changes along the phase velocity in the longitudinal direction. Therefore, this embodiment of this application is intended to propose the extended slow-wave structure with the full-cycle gradient phase velocity, and only the amplitude change function A(z) and the cycle change function p(z) of the folded slow-wave line are restricted. The folded slow-wave line may be represented by a general function relationship l_{SWS}(z)=A(z)P(z), where a change relationship of the slow-wave line in the horizontal direction (namely, the x direction) is A(z), and a change relationship of the slow-wave line in the vertical direction (namely, the z direction) is P(z), A(z) may be a function that continuously and progressively increases the z direction, and P(z) may be a function that continuously and progressively decreases in the z direction.

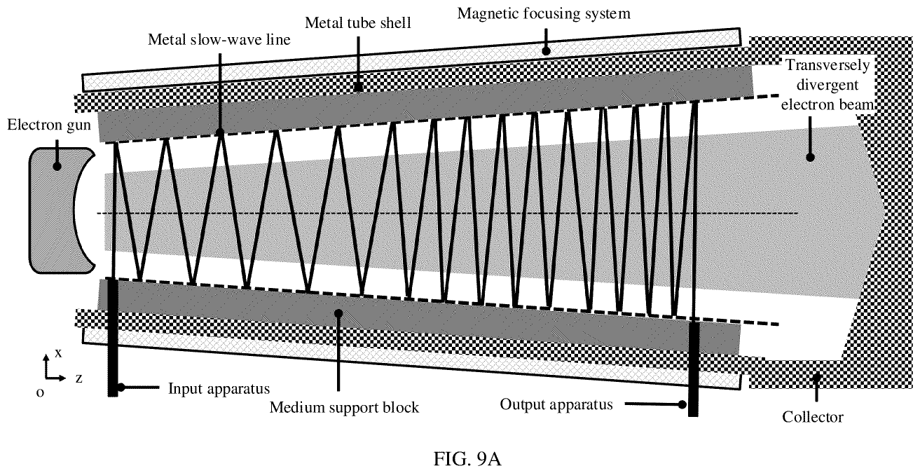

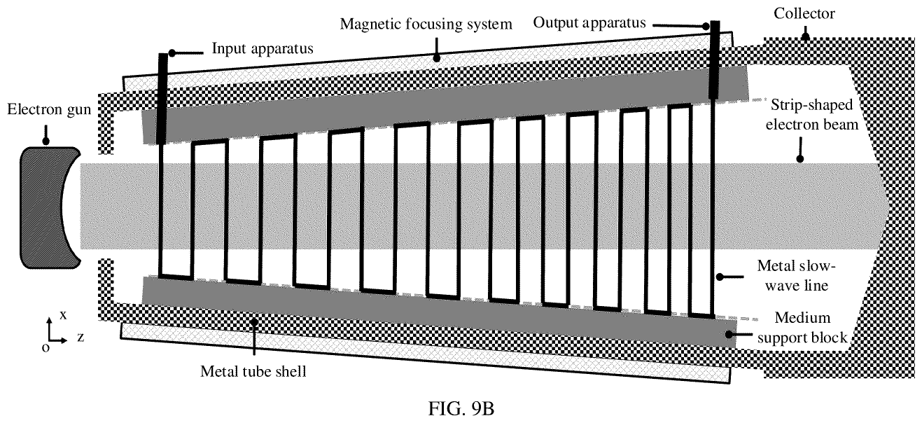

FIG. 9A is a diagram of a traveling wave tube including a slow-wave structure with a V-shaped folding line according to an embodiment of this application. The traveling wave tube includes an electron gun, an input and output apparatus, a magnetic focusing system, a slow-wave structure, and a collector. The slow-wave structure includes a metal folding line, a metal tube shell, and a dielectric support block. The dielectric support block is insulated from the metal tube shell and is configured to support the folding line. Electrons emitted by the electron gun pass through a slow-wave circuit under beam bunching of the focusing system and finally enter the collector. An electromagnetic wave signal is input into the slow-wave structure through an input apparatus. The electromagnetic wave transmitted along the metal folding line interacts with the electron beam passing through the slow-wave circuit, so that kinetic energy of the electrons is converted into energy of the electromagnetic wave, and the electromagnetic wave signal is amplified. The amplified electromagnetic wave signal is coupled into an external circuit through an output apparatus. The folding line of the slow-wave structure is a V-shaped folded structure. In the transmission direction (namely, the longitudinal direction or the z direction) of the electron beam, the transverse amplitude of the folding line gradually increases, and the longitudinal cycle gradually decreases. The electron beam in FIG. 9B is illustrated as a transversely divergent electron beam. Parameters of the folding line may be optimized, so that the phase velocity of the electromagnetic wave transmitted along the folding line matches a velocity of the electron beam, thereby improving electron efficiency. In addition, the folding line with a transverse size extension may match the transverse divergence electron beam. In this way, a density of the electron beam can be reduced, and it can also be avoided that the slow-wave structure is bombarded by electrons at an output section, affecting operating stability of the traveling wave tube.

FIG. 9B is a diagram of a traveling wave tube including a slow-wave structure with an S-shaped folding line according to an embodiment of this application. The traveling wave tube includes an electron gun, an input and output apparatus, a magnetic focusing system, a slow-wave structure, and a collector. The traveling wave tube in FIG. 9A is similar to the traveling wave tube in FIG. 9B, and a difference lies in that the folding line of the slow-wave structure of the traveling wave tube in FIG. 9B is an S-shaped folded structure, and the electron beam in FIG. 9B is shown as a strip-shaped electron beam. In the transmission direction (namely, the longitudinal direction or the z direction) of the electron beam, the transverse amplitude of the folding line gradually increases, and the longitudinal cycle gradually decreases. The traveling wave tube shown in FIG. 9B can improve electronic efficiency, expand a bandwidth, and improve operating stability of the traveling wave tube. Although the electron beam in FIG. 9B is illustrated as the strip-shaped electron beam, the electron beam may alternatively be a transversely divergent electron beam or a plurality of circular electron beams, depending on the design of the magnetic focusing system. For the transversely divergent electron beam, the magnetic focusing system can be easily designed, and the electronic efficiency and operating stability can be further improved.

Although the embodiments shown in FIG. 4A to FIG. 9B are folding line type slow-wave structures, this embodiment of this application is not limited thereto. Features of the folding line described in FIG. 4A to FIG. 9B may be further applicable to a folded waveguide.

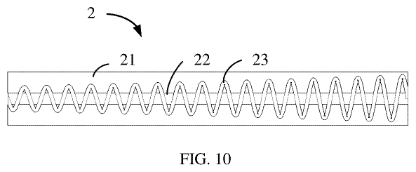

FIG. 10 is a diagram of a slow-wave structure 2 including a folded waveguide according to an embodiment of this application. The slow-wave structure 2 includes the folded waveguide 23. The folded waveguide 23 has an amplitude in a transverse direction and a cycle in a longitudinal direction. The amplitude, the cycle, or both of the folded waveguide 23 may continuously change in the longitudinal direction. The slow-wave structure 2 may further include a metal waveguide wall 21 and an electron beam channel 22. The folded waveguide 23 may have a sine-cosine shape, a V shape, an S shape, a U shape, or the like. In some embodiments, a transverse amplitude of the folded waveguide 23 progressively increases in the longitudinal direction. In some embodiments, a longitudinal cycle of the folded waveguide 23 progressively decreases in the longitudinal direction. In some embodiments, a transverse amplitude of the folded waveguide 23 progressively increases in the longitudinal direction, and a longitudinal cycle progressively decreases in the longitudinal direction. In some embodiments, a change of a transverse amplitude of the folded waveguide 23 in the longitudinal direction may satisfy an exponential function, a logarithmic function, a polynomial function, or a trigonometric function. In some embodiments, a change of a longitudinal cycle of the folded waveguide 23 in the longitudinal direction may satisfy an exponential function, a logarithmic function, a polynomial function, or a trigonometric function.

In some embodiments, the folded waveguide 23 may include a plurality of segments of folded waveguides. In an embodiment, a folded waveguide segment close to an input end may have a constant transverse amplitude and a constant longitudinal cycle. In another embodiment, a cycle progressive decrease factor of a longitudinal cycle of a folded waveguide segment close to an input end may be less than a cycle progressive decrease factor of a longitudinal cycle of a folded waveguide segment close to the output end. In another embodiment, an amplitude increase factor of a transverse amplitude of a folded waveguide segment close to an input end may be less than an amplitude increase factor of a transverse amplitude of a folded waveguide segment close to the output end. In another embodiment, transverse amplitudes and longitudinal cycles of adjacent end parts of two folded waveguide segments are the same or continuously change.

Embodiments of this application provide a slow-wave structure and a planar traveling wave tube including the slow-wave structure. The transverse amplitude of the folded waveguide structure gradually increases, or the longitudinal cycle gradually decreases, or both are satisfied, so that the electromagnetic wave transmitted in the folded slow-wave line gradually changes along the phase velocity in the longitudinal direction. The continuous gradient slow-wave structure can reduce reflection of the slow-wave structure, effectively suppress backward wave oscillation, and obtain a wider operating bandwidth. In addition, through the transverse amplitude and/or the longitudinal cycle of the waveguide structure, the electromagnetic wave transmitted in the folded slow-wave line may continuously change, to better match the velocity of the electron beam, thereby improving interaction efficiency. In addition, the slow-wave structure in this embodiment of this application is simpler, and is easy to process and manufacture. The full-cycle gradient phase velocity can be implemented in the entire slow-wave structure through a small quantity of variable parameters (for example, the amplitude increase factor and the cycle progressive decrease factor). This helps implement global optimization through an optimization algorithm to achieve high electronic efficiency.

In addition, this application provides various example embodiments, as described and shown in the accompanying drawings. However, this application is not limited to the embodiments described and illustrated in this specification, but may be extended to other embodiments. Without departing from the scope of the described implementations, many modifications and variations are apparent to a person of ordinary skill in the art. Selection of the terms used in this specification is intended to well explain principles of the implementations, actual applications, or improvements to technologies in the market, or to enable another person of ordinary skill in the art to understand the implementations disclosed in this specification. In the specification, the reference to “one embodiment”, “this embodiment”, “the embodiments”, or “some embodiments” means that the described specific features, structures, or features are included in at least one embodiment, and the occurrence of these phrases in various places in the specification does not necessarily mean a same embodiment.

Although the embodiments have been described in language dedicated to structural features and/or method actions, it should be understood that the subject matter defined in the appended representation is not necessarily limited to the specific features or actions described. Instead, specific features and actions are disclosed as example forms of implementing the claimed subject matter.

1. A slow-wave structure, comprising:
a folded waveguide structure, wherein the waveguide structure has a cycle in a longitudinal direction and an amplitude in a transverse direction perpendicular to the longitudinal direction, and at least one of an amplitude of a first part of the waveguide structure and a cycle of the first part gradually changes in the longitudinal direction.

2. The slow-wave structure according to claim 1, wherein the first part of the waveguide structure satisfies at least one of the following:
the amplitude of the first part continuously increases in the longitudinal direction; or
the cycle of the first part continuously decreases in the longitudinal direction.

3. The slow-wave structure according to claim 2, wherein the amplitude or the cycle of the first part satisfies any one of the following function relationships: an exponential function, a logarithmic function, a polynomial function, or a trigonometric function.

4. The slow-wave structure according to claim 1, wherein an amplitude of a second part of the waveguide structure in the transverse direction and a cycle in the longitudinal direction remain unchanged in the longitudinal direction, and the second part is closer to an input end of the slow-wave structure than the first part.

5. The slow-wave structure according to claim 1, wherein an amplitude of a second part of the waveguide structure in the transverse direction is less than the amplitude of the first part, the amplitude of the second part continuously increases in the longitudinal direction at an amplitude change rate less than an amplitude change rate of the first part, and the second part is closer to an input end of the slow-wave structure than the first part.

6. The slow-wave structure according to claim 1, wherein a cycle of a second part of the waveguide structure in the longitudinal direction is greater than the cycle of the first part, the cycle of the second part continuously decreases in the longitudinal direction at a cycle change rate less than a cycle change rate of the first part, and the second part is closer to an input end of the slow-wave structure than the first part.

7. The slow-wave structure according to claim 4, further comprising an attenuator disposed between the first part and the second part.

8. The slow-wave structure according to claim 1, wherein the waveguide structure comprises a folded waveguide.

9. The slow-wave structure according to claim 1, wherein the waveguide structure comprises a folding line.

10. The slow-wave structure according to claim 9, further comprising:
a metal tube shell, extending in the longitudinal direction; and
a dielectric support member, insulated from the metal tube shell and supporting the waveguide structure.

11. The slow-wave structure according to claim 9, wherein the folding line comprises double layers of folding lines.

12. The slow-wave structure according to claim 11, wherein the slow-wave structure comprises a first ridge structure and a second ridge structure that are located on opposite sides of the double layers of folding lines, and the first ridge structure and the second ridge structure are parallel to planes on which the double layers of folding lines are located, respectively.

13. A traveling wave tube, comprising:
an input/output apparatus, an electronic transceiver component, a focusing component, and a slow-wave structure, wherein
the input/output apparatus is configured to input an electromagnetic wave to an input end of the slow-wave structure, and output the electromagnetic wave from an output end of the slow-wave structure;
the slow-wave structure, comprising: a folded waveguide structure, wherein the waveguide structure has a cycle in a longitudinal direction and an amplitude in a transverse direction perpendicular to the longitudinal direction, and at least one of an amplitude of a first part of the waveguide structure and a cycle of the first part gradually changes in the longitudinal direction.

14. The traveling wave tube according to claim 13, wherein the electronic transceiver component is configured to emit the electron beam on a planar cathode emitting surface.

15. The traveling wave tube according to claim 14, wherein the electron beam is a strip-shaped electron beam or a transversely divergent electron beam.

16. An electronic device, comprising:
a power supply apparatus, and a traveling wave tube powered by the power supply apparatus;
the traveling wave tube, comprising: an input/output apparatus, an electronic transceiver component, a focusing component, and a slow-wave structure, wherein
the input/output apparatus is configured to input an electromagnetic wave to an input end of the slow-wave structure, and output the electromagnetic wave from an output end of the slow-wave structure;
the slow-wave structure, comprising: a folded waveguide structure, wherein the waveguide structure has a cycle in a longitudinal direction and an amplitude in a transverse direction perpendicular to the longitudinal direction, and at least one of an amplitude of a first part of the waveguide structure and a cycle of the first part gradually changes in the longitudinal direction.
